(19) United States
(12) Patent Application Publication
(10) Pub. No.: US 2005/0137916 A1
(43) Pub. Date: Jun. 23, 2005

(54) Error detection and recovery system and method for common use self-service kiosks

(75) Inventor: James L. McElhannon, Broken Arrow, OK (US)

Correspondence Address: OLIFF & BERRIDGE, PLC, P.O. BOX 19928, ALEXANDRIA, VA, 22320, US

(73) Assignee: ARINC INCORPORATION, Annapolis, MD (US)

(21) Appl. No.: 10/736,645

(22) Filed: Dec. 17, 2003

(51) Int. Cl. G06F 17/60

(52) U.S. Cl. 705/5

(57) ABSTRACT

In an automated common use self-service kiosk, an automated error detection and recovery system automatically reports errors to an agent and prints a recovery coupon to be delivered to a user and presented to an agent. The recovery coupon contains a pointer to error condition data to allow the agent to quickly determine the cause of the error and possible corrections.

### BACKGROUND OF THE INVENTION

1. Field of Invention

This invention relates generally to common use self-service (CUSS), or stand alone, kiosks. More specifically, this invention relates to systems and methods for error detection and recovery in CUSS kiosks, thereby allowing the user to more rapidly complete a desired task.

2. Description of Related Art

CUSS kiosks are commonly used in many industries. For example, banks, entertainment ticket services, florists, greeting cards, and airline ticket services use kiosks for a variety of purposes.

U.S. Pat. No. 6,446,045 to Storie et al. discloses a method and apparatus that allows sellers to present their inventory and services in a choice of one or a variety of supported media outlets such as newspapers, magazines, catalogs, billboards, radio and interactive kiosks. The invention creates a presentation for each of the desired media outlets the seller has chosen. The invention also allows for the verification of a purchase. In an exemplary embodiment of the invention a transaction processing program creates transaction messages to update the seller of any change in inventory as a result of a transaction. If the transaction message is found to contain erroneous or missing data, then error messages are sent to a central controller, the management or administrator, and to the buyer. In the event of a physical failure of the delivery of the purchased item or an identification of the purchaser, the management would manually confirm the identification of the buyer and process the purchase.

U.S. Pat. No. 6,058,372 discloses a stand alone, interactive, self-service kiosk for initializing and copying computer hard drives. The kiosk is programmed to conduct a dialog with a customer instructing them to connect their original and replacement hard drives to the kiosk. Once the hard drives are connected, a microprocessor automatically identifies the original and replacement hard drives, configures the replacement hard drive and copies all programs and data from the original hard drive to the replacement hard drive. When the copying process is complete, a printed report is generated with further instructions on installation of the hard drive and detailed information about any errors encountered in the data during transfer.

In the airline industry, the typical approach to detecting and resolving errors is to simply refer the passenger to an agent. For example, when an automated interaction between the CUSS application on a kiosk and the departure control system (DCS) used by a particular airline fails, known CUSS applications merely inform the passenger to proceed to an agent for assistance. Such CUSS applications are unacceptable for several reasons. Firstly, the passenger is inconvenienced by standing in a second line after waiting for use of a kiosk. Secondly, many airlines offer the passengers incentives (such as frequent flyer miles) for using the kiosks instead of an agent. If the passenger tries to use the kiosk but is unsuccessful and requires an agent's intervention, it is unclear to the passenger if he or she will receive the incentive. Thirdly, in existing systems, the agent has no information regarding the source of the problem or possible solutions. For business travelers with large, complex itineraries, especially with international destinations involved, the search for the problem is time consuming.

As the use of CUSS kiosks becomes more common in the major airports throughout the world, the error recovery functionality becomes of key interest. A typical kiosk application is designed to ask the passenger a series of simple questions, and the kiosk performs a series of commands that an agent would normally manually enter. Upon detecting a failure at the kiosk, most kiosk applications simply display a message on the display screen directing the passenger to see an agent. If a passenger has stood in line for a kiosk, and an error occurs, the passenger will not be happy about standing in line again for an agent to assist him. When the passenger comes to the agent, the agent is given no information about the failure, no information about which commands in the series were successful, etc. The agent must manually begin the process over, probe into the passenger's information, and upon manually detecting the error, correct it, and then issue the passenger his or her travel documents.

### SUMMARY OF THE INVENTION

This invention overcomes the limitations of existing error detection and recovery systems by providing both the passenger and the agent improved access to information. In an exemplary embodiment of the invention, upon the detection of a failure of a command in an automated series of commands that the kiosk issues, instead of simply displaying a message instructing the passenger to see an agent, the kiosk prints a “recovery coupon” on the kiosk's boarding pass printer. The passenger is instructed to take the coupon to an agent for assistance.

In an exemplary embodiment of the invention, depending upon the type of boarding pass printer and paper stock in the printer, the recovery coupon may consist of a simple barcode on plain thermal paper, or it may consist of an encoded magnetic stripe on the back of an ATB2 (Automated Ticket and Boarding Pass) coupon. If a barcode is used, the agent scans the barcode. If an ATB2 document is used, the agent inserts the document into the boarding pass reader/printer, which reads the magnetic stripe. Either way, the system uses the information given to it on the recovery coupon to look-up the passenger's information. From this information, the system can determine which commands at the kiosk succeeded and which failed. The system offers solutions to the agent based on the information provided on the coupon. The passenger's information is displayed to the agent, showing the successful transactions and the failed transactions. The agent corrects the problem, or problems, with the information provided by the coupon, and completes the processing by restarting the automated series of commands from the last successful transaction. The travel documents, i.e., boarding pass and/or baggage tags are printed and given to the passenger.

### BRIEF DESCRIPTION OF THE DRAWINGS

Various embodiments of this invention will be described in detail, with reference to the following figures, wherein:

FIG. 1 is a schematic representation of a CUSS kiosk according to an exemplary embodiment of the invention;

FIG. 2 is a schematic representation of the systems according to an exemplary embodiment of the invention;

FIG. 3 is a flow chart representing the functionality of error detection provided by an exemplary embodiment of the invention;

FIG. 4 is a flowchart representing the process of error detection occurring at a CUSS kiosk according to an exemplary embodiment of the invention;

FIG. 5 is a flowchart representing the process of error recovery occurring at an agent workstation according to an exemplary embodiment of the invention;

FIG. 6 is a flowchart representing the process of security alerts according to an exemplary embodiment of the invention; and

FIGS. 7a and 7b show exemplary embodiments of a recovery coupon according to the invention.

### DETAILED DESCRIPTION OF PREFERRED EMBODIMENTS

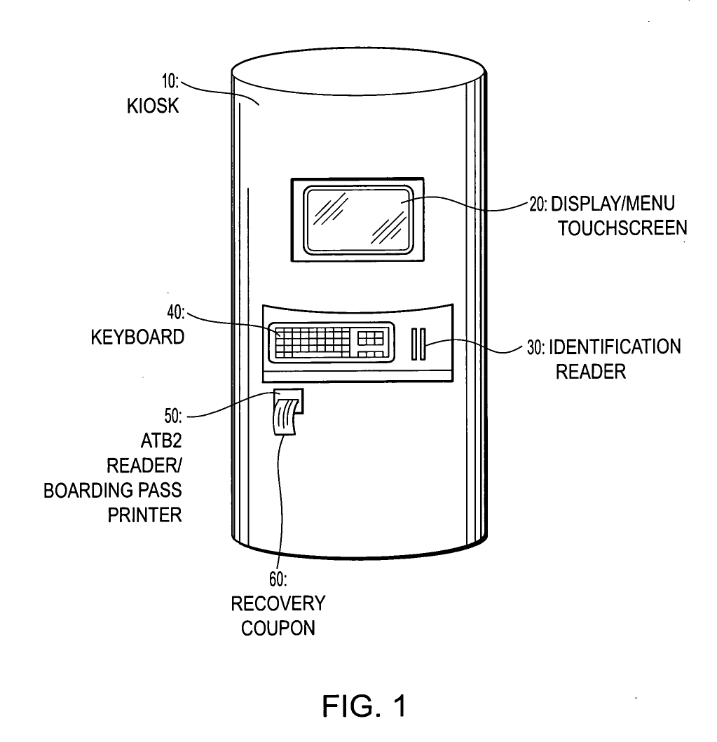

FIG. 1 is a schematic representation of a CUSS kiosk according to an exemplary embodiment of the invention. As shown in FIG. 1, a CUSS kiosk 10 includes a display screen 20 for displaying questions and commands to the user. The display screen 20 may also be a touch screen to provide an input device for the user to respond to the questions and commands issued by the system. An identification reader 30, such as a bar code reader, magnetic stripe reader, or the like is provided to allow the user to scan his or her means of identification, such as a driver's license, into the system when prompted by the system. An operator interface, such as a keyboard 40 may also be provided to allow the user to manually input the proper alpha-numerical sequence displayed on the driver's license, or other means of identification, if not provided with a stripe readable by the identification reader 30.

An ATB2 reader/boarding pass printer 50 is provided on the kiosk 10 to allow an existing ticket/boarding pass to be read via an encoded stripe disposed on the ticket/boarding pass. The printer 50 also provides the user with a boarding pass and/or baggage tags upon successful completion of the check-in process.

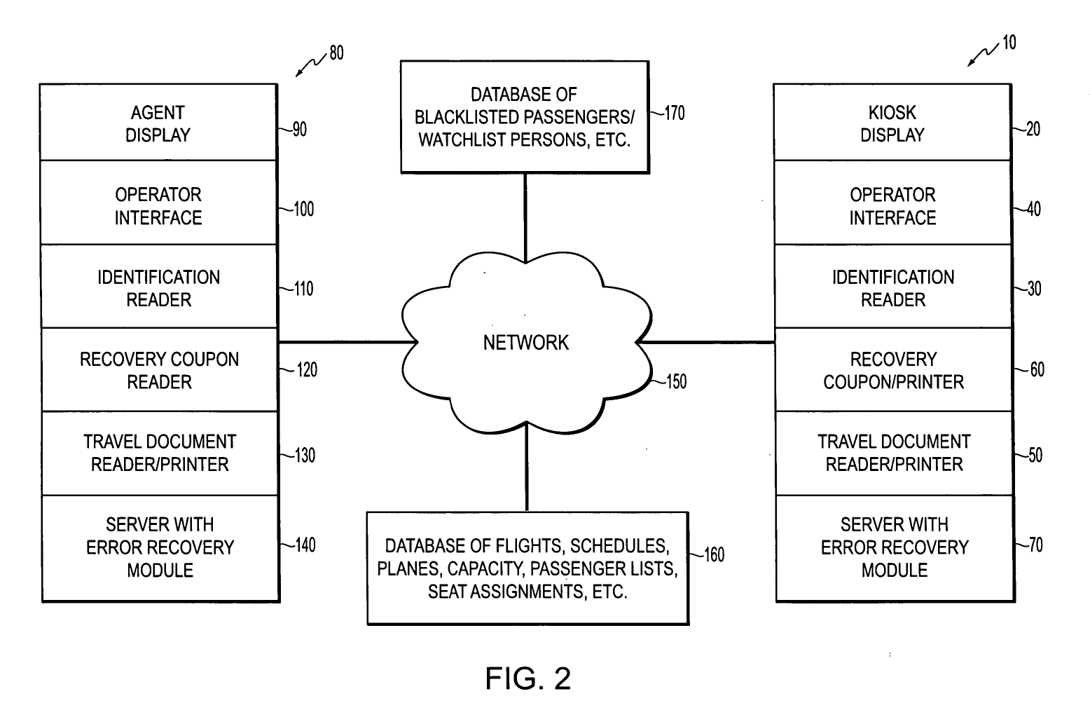

The kiosk 10 may also include a server 70 (FIG. 2) on which the error detection module of the CUSS application of the present invention is installed. In an alternative embodiment of the invention, the CUSS application may be resident at a remote location. In either of these embodiments, the kiosk 10, and the CUSS application is integrated with the common language facility (CLF) applications and departure control systems (DCS) used by the airline/agent.

FIG. 2 is a schematic representation of the systems according to an exemplary embodiment of the invention. As shown in FIG. 2, the kiosk 10 is networked to the agent workstation 80 via the network 150. The agent workstation 80 includes a display screen 90. The display screen 90 may also be a touch screen to provide an input device for the agent to respond to the questions and commands issued by error recovery module of the CUSS application of the invention. A identification reader 110, such as a bar code reader, magnetic stripe reader, or the like is provided to allow the agent to scan a passenger's means of identification, such as a driver's license, into the system when prompted by the system. An operator interface 100, such as a keyboard may also be provided to allow the agent to manually input the proper alpha-numerical sequence displayed on the driver's license, or other means of identification, if not provided with a stripe readable by the identification reader 110.

An ATB2 reader/boarding pass printer 130 is provided at the agent workstation 80 to allow the agent to read an existing ticket/boarding pass via an encoded stripe disposed on the ticket/boarding pass. The printer 130 also prints the travel documents, such as a boarding pass and/or baggage tags upon successful completion of error recovery.

A database 160 is also connected to the network 150. The database may contain, for example, scheduled flights and flight numbers, airplane capacity, passenger lists, seat assignments, and the like. A passenger using a kiosk 10 to check-in would respond to questions and commands that require access to such information during the check-in process. Similarly, the database 160 is also connected to the agent workstation 80 via the network 150 to allow an agent access to information necessary to assist a passenger during error recovery.

In an exemplary embodiment of the system, a database 170 contains lists of “blacklisted” passengers, “watch list” persons, reported stolen tickets, and the like. The database 170 is networked to both the kiosk 10 and the agent workstation 80 to obtain and report information that may warrant a security alert.

Integration of the CUSS applications with the existing systems used by the airline allows agents to use the information provided by passengers at the kiosks 10 to search for passenger by name, FFP number, flight, and the like. The information made available through the kiosks 10 may also be used to assist in determining flight lists, destinations, and the like. Management reports and passenger processing will also be expedited by the integration of the CUSS application of this invention with existing airport systems.

In an exemplary embodiment of the invention, upon the detection of a failure of a command in the automated series of commands that the kiosk 10 issues, instead of simply displaying a message instructing the passenger to see an agent, the kiosk 10 prints a “recovery coupon” 60 on the kiosk's boarding pass printer 50. The passenger is instructed to take the coupon to an agent for assistance.

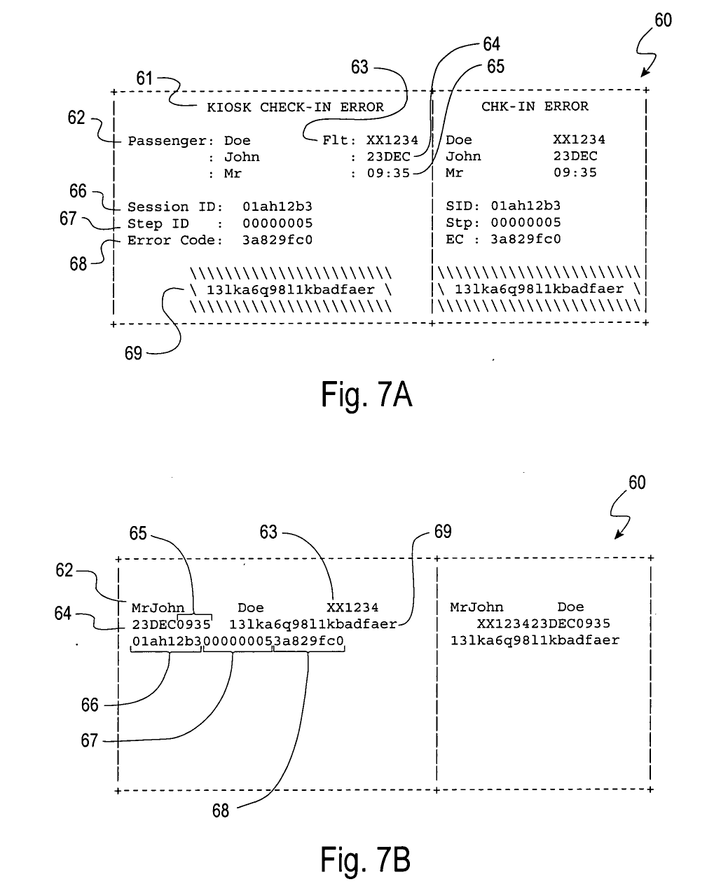

The recovery coupon 60 contains a pointer to the error condition's data (FIGS. 7a and 7b). As shown in FIGS. 7a and 7b, recovery coupons contain information to assist in the identification of the passenger and the type of error encountered at the kiosk. For example, in FIG. 7a, a recovery coupon 60 is printed when an error is encountered by a passenger during check-in at a kiosk 10. In the exemplary embodiment shown in FIG. 7a, the recovery coupon 60 includes a heading line 61 that serves to differentiate the recovery coupon 60 from other documents, such as a boarding pass or ticket. The coupon 60 also includes the passenger name 62, flight number 63, departure date 64 and departure time 65.

The session ID 66 is a unique alphanumeric identifier used to reference the particular passenger's kiosk session with the CLF engine layer. The step ID 67 is used to identify where in the identified session the error was encountered. The error code 68 identifies why the identified step in the identified session encountered the error. The recovery coupon 60 may also include a bar code 69 representing the session ID 66, step ID 67 and the error code 68. The bar code may be read by a bar code reader at the agent workstation 80.

FIG. 7b shows an alternative embodiment of the recovery coupon 60. In the exemplary embodiment, the coupon 60 includes a magnetic stripe that is capable of carrying data. Such data may include for example, the departure date 64 and departure time 65, the session ID 66, step ID 67 and the error code 68. The magnetic stripe may also include the value represented by the bar code 69.

Although the recovery coupon 60 is described in reference to FIGS. 7a and 7b, other embodiments are contemplated by this invention.

Depending upon the type of boarding pass printer and paper stock in the printer, the recovery coupon 60 may consist of a simple barcode on plain thermal paper, for example. In another exemplary embodiment of the invention, the recovery coupon 60 may consist of an encoded magnetic stripe on the back of an ATB2 coupon. If a barcode is used, the agent scans the barcode at the recovery coupon reader 120. If an ATB2 document is used, the agent inserts the document into the boarding pass reader/printer 130, which reads the magnetic stripe on the document. The error recovery module of the system uses the information provided on the recovery coupon 60 to view the passenger's information. From this information, the system can determine which commands succeeded and which failed. The system offers solutions to the agent based on the information provided on the coupon 60. The agent corrects the problem, or problems, with the information, and completes the processing by restarting the automated series of commands from the last successful transaction and then issues the passenger his or her travel documents.

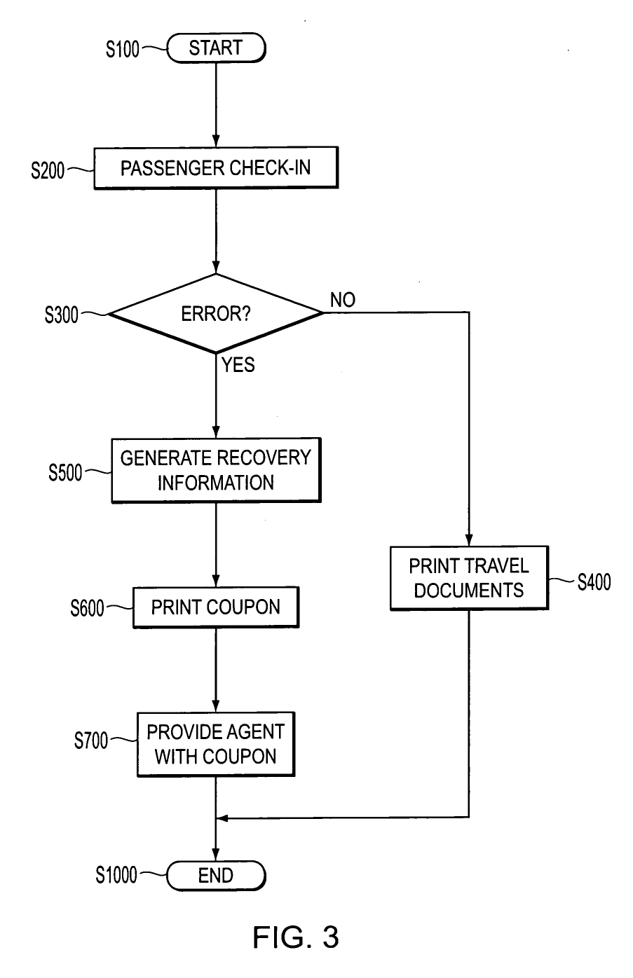

FIG. 3 is a flow chart representing the functionality of error detection provided by an exemplary embodiment of the invention. As shown in FIG. 3, the process begins at step S100. At step S200 a passenger using a CUSS kiosk 10 checks-in by responding to an automated series of commands and questions. For example the passenger may be asked to select the desired language in which to conduct the check-in process, select seat assignments, present identification, and the like.

During the check-in step S200 the error detection module of the system detects for errors at step S300. If no error is detected then operation proceeds to step S400 and travel documents for the passenger are printed and operation ends at step S1000.

In the event an error is detected, operation proceeds to step S500 and the system generates information pertaining to the error and creates a pointer to the error. The pointer and/or the generated information is printed on a recovery coupon 60 at step S600 and instructions are given to the passenger to bring the coupon 60 to an agent workstation 80 for assistance. At step S700 an agent is provided with the coupon 60 and operation of the error detection module ends at step S1000.

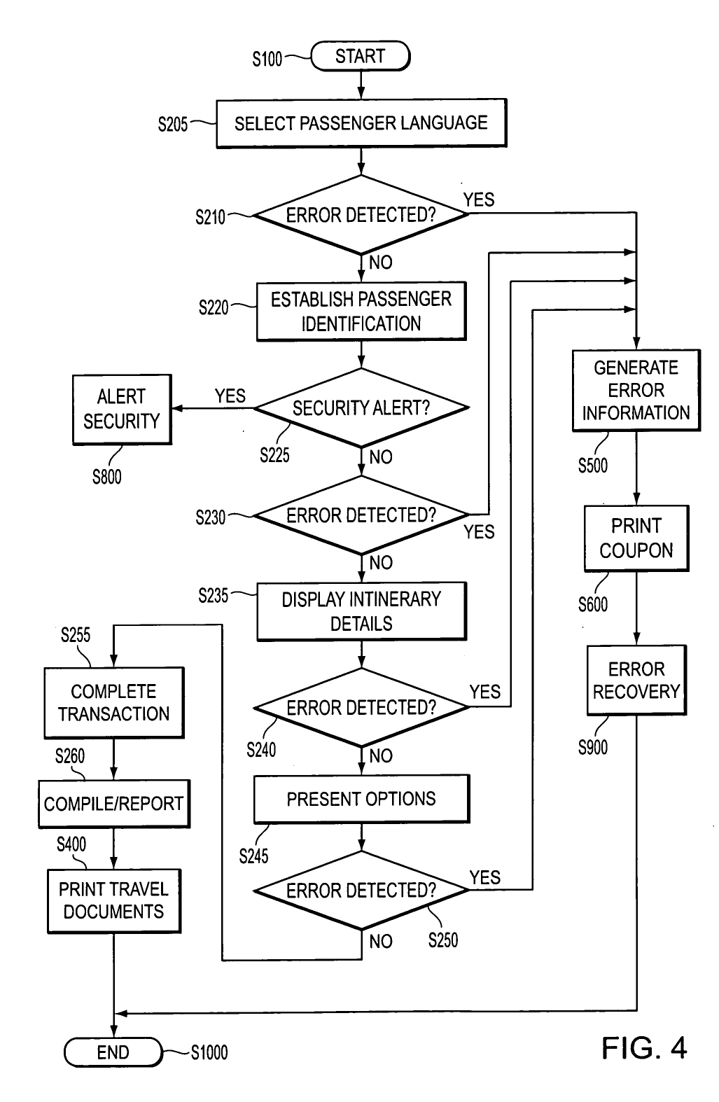

FIG. 4 is a flowchart representing the process of error detection occurring at a CUSS kiosk according to an exemplary embodiment of the invention. As shown in FIG. 4, operation begins at step S100 and proceeds to step S205 where the passenger is prompted to select the desired language which the passenger wishes to use during the automated boarding process. For example, the display screen 20 of the kiosk may display a series of national flags representing various countries and internationalized text to the user. Once the language is selected, all text displayed by the CUSS application, except dynamic data from the host, will be displayed in the chosen language.

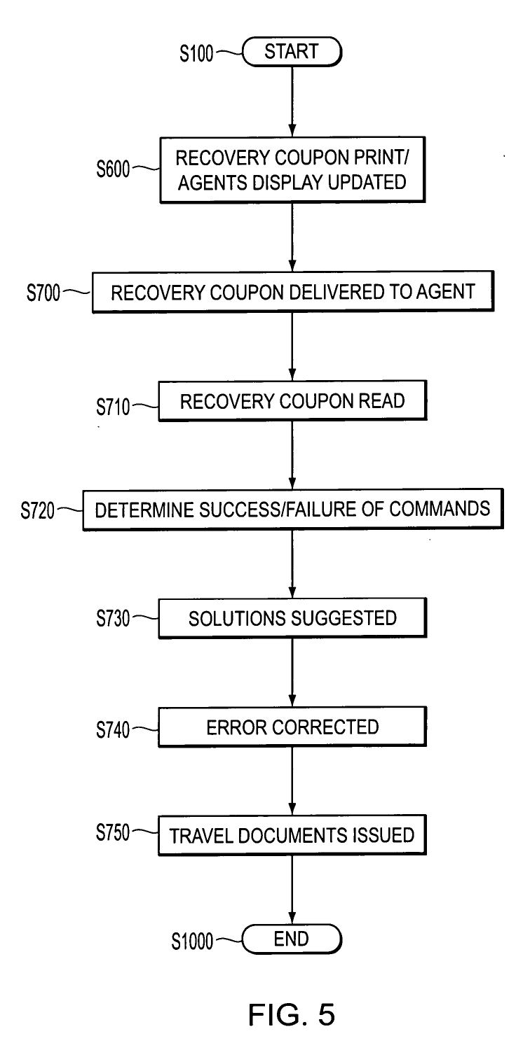

If a command failure is detected at step S210 an error message is displayed on the display screen 20 and error information is generated by the error detection module of the system at step S500. A recovery coupon 60 is printed at step S600 at the kiosk printer 50, and the agent's display 90 is updated. The passenger is prompted to take the recovery coupon 60 to an agent workstation 80 for assistance and the application yields to the launch application. Operation of the system then continues at the error recovery step S900 (FIG. 5).

In the event no input is received by the system within a predetermined period of time, the application may yield to the launch application, e.g., the screen 20 may default to the screen displayed at step S200 or default to another pre-programmed screen such as a list of airlines from which to select, advertisements, or the like.

If no error is detected operation continues at step S2220. At step S220 the passenger must provide proof of identification. For example, a passport, credit card, frequent flyer program (FFP) card, ATB2 document, or the like, may be used for identification purposes. The proof of identification may be read by a identification reader 30 or, optionally, the user may enter the identification number or code on the identification, such as a FFP card, via a keyboard 40. If an ATB2 document, such as an existing ticket or boarding pass, is presented, the ATB2 document is fed into the reader/boarding pass printer 50 and the information encoded thereon is read.

Once entered, the data obtained by the system will be used in various host transactions, such as accessing the database 160 in an attempt to locate the passenger's itinerary. If a match is found, operation continues to step S235.

The system also uses the information to check for potential security issues at step S225. If the information provided at step S215 reveals the presence of a stolen ticket, a “blacklisted” or “watch list” person, or other potential security issue, then a security alert situation arises and operation proceeds to step S800 (FIG. 4) and security authorities are notified.

If the security alert check step S225 does not detect a problem, operation continues to step S230 where the system detects for errors. If an error is detected, such as no match is found for the submitted identification, or another command failure is detected, an error message is displayed on the display screen 20 and error information is generated by the error detection module of the system at step S500. A recovery coupon 60 is printed at step S600 at the kiosk printer 50, and the agent's display 90 is updated. The passenger is prompted to take the recovery coupon 60 to an agent workstation 80 for assistance and the application yields to the launch application. Operation of the system then continues at the error recovery step S900 (FIG. 5).

In the event no input is received by the system within a predetermined period of time, the application may yield to the launch application, e.g., the screen 20 may default to the screen displayed at step S200 or default to another preprogrammed screen such as a list of airlines, advertisements, or the like.

At step S235, the itinerary information obtained from check-in process thus far is displayed to the passenger. The passenger is asked to confirm that the information shown on the display screen 20, such as the destination, is correct. If the passenger confirms the itinerary information, operation continues at step S245.

If the passenger indicates the itinerary information displayed is incorrect, or another command failure is detected at step S250, an error message is displayed on the display screen 20 and error information is generated by the error detection module of the system at step S500. A recovery coupon 60 is printed at step S600 at the kiosk printer 50, and the agent's display 90 is updated. The passenger is prompted to take the recovery coupon 60 to an agent workstation 80 for assistance and the application yields to the launch application. Operation of the system then continues at the error recovery step S900 (FIG. 5).

In the event no input is received by the system within a predetermined period of time, the application may yield to the launch application, e.g., the screen 20 may default to the screen displayed at step S200 or default to another preprogrammed screen such as a list of airlines, advertisements, or the like.

At step S245, the passenger is presented with a list of options. The options displayed may vary based on the particular airline being used by the passenger, the configuration of the departure control system (DCS) used by the airline, and the context and state of the passenger's itinerary, for example. In an exemplary embodiment of the invention, such options may include, selecting or changing seat assignment, selecting or changing FFP number, re-start check-in, and the like.

At step S250 the system detects for errors. If an error occurs or another command failure is detected, an error message is displayed on the display screen 20 and error information is generated by the error detection module of the system at step S500. A recovery coupon 60 is printed at step S600 at the kiosk printer 50, and the agent's display 90 is updated. The passenger is prompted to take the recovery coupon 60 to an agent workstation 80 for assistance and the application yields to the launch application. Operation of the system then continues at the error recovery step S900 (FIG. 5).

In the event no input is received by the system within a predetermined period of time, the application may yield to the launch application, e.g., the screen 20 may default to the screen displayed at step S200 or default to another preprogrammed screen such as a list of airlines, advertisements, or the like.

Upon successful completion of step S245, operation continues at step S255. At step S255, the check-in process is completed with a confirmed check-in, i.e., confirmed itinerary, seat assignment, issuance of a boarding pass and/or baggage tags.

Upon completion of step S255, operation continues at step S260. At step S260, the system will create and/or save information necessary to provide a report including, for example, the number of passengers checked-in per time period, the number of boarding passes printed per time period, the number of baggage tags printed per time period, statistical information related to timing, such as the average time spent on a given screen, average total time, and the like. The report is made available to management, as well as for display on the agents display and operation continues at step S400 where travel documents are printed for the passenger.

Upon completion of step S400, operation continues to step S800, where the process ends.

FIG. 5 is a flowchart representing the process of error recovery according to an exemplary embodiment of the invention. In FIG. 5, operation begins at step S100 and continues to step S600. Upon detection of a failure during check-in, a recovery coupon 60 containing a pointer to the error condition's data is printed at the boarding pass printer 50 and the agent's display 90 is updated. At step S700 the passenger delivers the recovery coupon 60 to the agent.

Operation continues at step S710 where, upon receipt of the recovery coupon 60, the agent reads the information contained on the coupon 60 at either the recovery coupon reader 120 or the travel document reader/printer 130. Depending upon the type of boarding pass printer and paper stock in the printer, the recovery coupon 60 may consist of a simple barcode on plain thermal paper, or may include a stripe encoded with the pointer, for example.

The error recovery module of the system uses the information provided on the recovery coupon 60 to view the passenger's information and the error information generated by the error detection module. From this information, the system determines which commands succeeded and which failed at step S720. Depending on the successes and failures reported, the error recovery module of the system offers solutions to the agent based on the information provided on the coupon 60. See step S730.

Operation proceeds to step S740 where any detected errors are corrected. Once the errors are successfully corrected, operation continues a step S750 where the passengers travel documents are printed. Operation proceeds to step S100; where operation ends.

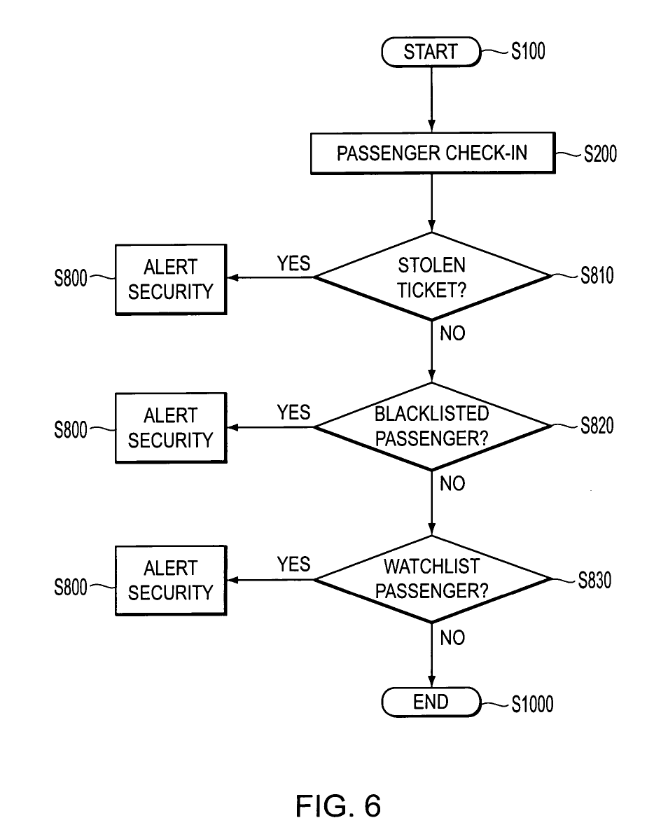

FIG. 6 is a flowchart representing the process of detecting potential security issues according to an exemplary embodiment of the invention. For example, in the event an attempt is made to process a reported stolen ticket at a kiosk 10, a security alert message is displayed on an agent's display and/or other displays, such as those monitored by security personnel. Similarly, if a “blacklisted” passenger or “watch list” passenger attempts to use a kiosk 10 employing the systems and methods of the invention, a security alert situation arises and alert messages are displayed as provided above.

In FIG. 6, operation starts at step S100 and proceeds to passenger check-in at step S200. At step S200 a passenger using a CUSS kiosk 10 checks-in by responding to an automated series of commands and questions. For example the passenger may be asked to select the desired language in which to conduct the check-in process, select seat assignments, present identification, and the like.

Operation continues at step S810 where the systems of the invention query the database 160, 170 to determine if the a ticket submitted by a passenger at a kiosk 10 during check-in has been reported lost or stolen. If the ticket has been reported lost or stolen then a security alert situation arises and operation proceeds to step S800 and security authorities are notified.

If step 810 produces a negative result, operation continues to step S820. At step S820 the system queries the database 170 to determine if the passenger is among those “blacklisted” by the airline. If the passenger has been blacklisted, then a security alert situation arises and operation proceeds to step S800 and security authorities are notified. If the passenger has not been “blacklisted”, operation continues at step S830.

During step S830, the systems query the database 160 to determine if the passenger is among those on a government “watch list”, such as wanted criminals, terrorists, and the like. If the passenger is identified as a “watch list” person then a security alert situation arises and operation proceeds to step S800 and security authorities are notified. In the event of these or other security concerns, an alert is sent to predetermined monitors, such as agents and security personnel, to provide notification of the situation. If the passenger is not on a “watch list” then operation continues at step S100 where operation ends.

While this invention has been described in conjunction with the exemplary embodiments outlined above, it is evident that many alternatives, modifications and variations will be apparent to those skilled in the art. Furthermore, although the exemplary embodiments are described for use in self-service kiosks at airports, it is contemplated that this invention may be used with kiosks in other venues. Accordingly, the exemplary embodiments of the invention, as set forth above, are intended to be illustrative, not limiting. Various changes may be made to the invention without departing from the spirit and scope thereof.

1. An automated error detection and recovery system for a common use self service kiosk in which a user reads commands and inputs responses in an automated process, comprising:
an error detection module that detects errors in the commands or responses that occurred during the automated process and generates error recovery information;
a printer associated with the error detection module, wherein the printer prints a recovery coupon containing information pertaining to the generated error recovery information;
a document reader to read the recovery coupon and the information pertaining to the generated error recovery information; and
an error recovery module that determines a status of the automated process and the commands or responses contained therein, based on the generated error recovery information contained in the recovery coupon.

2. The system of claim 1, wherein the error detection module is contained in a server connected to the kiosk.

3. The system of claim 1, wherein the reader and the error recovery module are located at an agent workstation separate from the kiosk.

4. The system of claim 1, wherein the error recovery module is contained in a server connected to an agent workstation separate from the kiosk.

5. The system of claim 1, wherein the automated error detection and recovery system is networked with an airport database.

6. The system of claim 1, wherein the user is an airline passenger and the automated process is a passenger check-in process.

7. The system of claim 1, wherein the error recovery module analyzes the status information and provides solutions for detected errors.

8. The system of claim 2, wherein the kiosk includes:
a display for displaying the commands to the user;
an operator interface for entering the responses to the commands; and
the printer for printing at least one of finalized document and the recovery coupon.

9. The system of claim 3, wherein the agent workstation includes:
a display for displaying generated error recovery information and proposed solutions for the detected errors;
an operator interface for executing the solutions;
a printer for printing finalized documents; and
the document reader to read the recovery coupon.

10. A method of error detection and recovery during automated passenger check-in at a common use self service kiosk in which a passenger reads commands and inputs responses in an automated check-in process, comprising:
monitoring the passenger check-in process for errors;
generating error recovery information when an error is detected;
printing a recovery coupon encoded with at least one of the generated error recovery information and a pointer to the error recovery information; and
correcting the detected error based on the information printed on the recovery coupon.

11. The method of claim 10, further comprising:
reading the information printed on the recovery coupon;
determining the status of the commands or responses based on the information read from the coupon; and
providing at least one solution for the errors based on the information read from the recovery coupon.

12. A method of error detection and recovery during automated passenger check-in at a common use self service kiosk in which a passenger reads commands and inputs responses in an automated check-in process, comprising:
monitoring the automated passenger check-in process at a kiosk;
generating error recovery information at the kiosk when an error is detected;
printing a recovery coupon at the kiosk encoded with at least one of the generated error recovery information and a pointer to the error recovery information using a printer at the kiosk;
generating a message for display on a kiosk display instructing the passenger to bring the recovery coupon to an agent;
reading the recovery coupon at an agent workstation;
determining a cause of the detected error based on the information read from the coupon;
providing at least one solution to the error;
correcting the error; and
printing passenger travel documents.

13. The method of claim 10, further comprising:
monitoring the passenger check-in process for potential security issues; and
notifying the proper authorities when a potential security issue is detected.
